(19) United States
(12) Patent Application Publication
(10) Pub. No.: US 2008/0259637 A1
(43) Pub. Date: Oct. 23, 2008

(54) OPTICAL PLATE AND BACKLIGHT MODULE USING THE SAME

(75) Inventor: SHAO-HAN CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/835,426

(22) Filed: Aug. 8, 2007

(30) Foreign Application Priority Data
Apr. 18, 2007 (CN) 200710200479.3

(51) Int. Cl. F21V 8/00; F21V 7/00

(52) U.S. Cl. 362/606; 362/617

(57) ABSTRACT

An exemplary optical plate (20) includes a light output surface, and a bottom surface opposite to the light output surface, a plurality of first protrusions formed on the bottom surface, and a lamp-receiving portion defined on the bottom surface. A backlight module (200) using the optical plate is also provided.

### CROSS-REFERENCE TO RELATED APPLICATIONS

This application is related to six copending U.S. patent applications, which are: applications serial no. [to be advised], Attorney Docket No. US13925, US13927, US13931, US14376, US14378, and US 14382, and entitled “OPTICAL PLATE AND BACKLIGHT MODULE USING THE SAME”. In all these copending applications, the inventor is Shao-Han Chang. All of the copending applications have the same assignee as the present application. The disclosures of the above identified applications are incorporated herein by reference.

### BACKGROUND OF THE INVENTION

1. Field of the Invention

The present invention relates to an optical plate, and a backlight module using the optical plate, the backlight module typically being used in apparatuses such as a liquid crystal display (LCD).

2. Discussion of the Related Art

In a liquid crystal display device, liquid crystal is a substance that does not itself radiate light. Instead, the liquid crystal relies on light received from a light source in order to provide displaying of images and data. In the case of a typical liquid crystal display device, a backlight module powered by electricity supplies the needed light.

Typically, FIG. 1 illustrates a backlight module 100. The backlight module 100 includes a housing 101, a reflective module 102, a light diffusion plate 103, a prism sheet 104, a light emitting diode 105, and a reflective sheet 106. The housing 101 includes a base 1011 and a plurality of connecting sidewalls 1013 extending from a periphery of the base 1011. The reflective module 102 is engaged with the housing 101, and located in the housing 101. The reflective module 102 defines a plurality of through holes (not labeled). The light diffusion plate 103 and the prism sheet 104 are stacked on a top of the sidewalls 1013 of the housing 101 in that order. The light emitting diode 105 includes a base portion 1053 and a light output portion 1051 disposed on the base portion 1053. The base portion 1053 is electrically connected with a printed circuit board (not labeled) that is fixed to the base 1011. The output portion 1051 of the light emitting diode 105 passes through the through hole of the reflective module 102. The reflective sheet 106 is located on a top the light output portion 1051 of the light emitting diode 105.

In use, light rays from the light emitting diode 105 are substantially reflected at the reflective module 102 and project into the light diffusion plate 103. After being scattered in the light diffusion plate 103, the light rays enter the prism sheet 104. The light rays are refracted by the prism sheet 104, and are thereby concentrated somewhat. This increases brightness of light illumination provided by the backlight module 100. Finally, the light rays propagate into an LCD panel (not shown) disposed above the prism sheet 104.

Generally, even though brightness above the light emitting diode 105 of the backlight module 100 can be decrease due to the light reflection of the reflective sheet 106, a plurality of dark areas around the light emitting diodes 105 still occur. Accordingly a brightness distribution of the backlight module 100 is still not uniform.

Therefore, what is desired is an optical plate and a backlight module using the optical plate that can overcome the above-described shortcomings.

### SUMMARY

An optical plate includes at least an optical plate unit. Each optical plate unit includes a light output surface, and a bottom surface opposite to the light output surface, a plurality of first protrusions formed on the bottom surface, and a lamp-receiving portion defined on the bottom surface.

A backlight module includes a housing, at least a point light source, a light diffusion plate, a light diffusion plate, and an optical plate. The housing has a base and a plurality of sidewalls extending from a periphery of the base. The at least a point light source has a light output portion located on the base. The light diffusion plate is positioned on a top of the sidewalls. An optical plate includes at least an optical plate unit. Each optical plate unit includes a light output surface, and a bottom surface opposite to the light output surface, a plurality of first protrusions formed on the bottom surface, and a lamp-receiving portion defined on the bottom surface. The light output portion is received in the lamp-receiving portion.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate and a backlight module using the optical plate. Moreover, in the drawings, like reference numerals designate corresponding parts throughout the several views, and all the views are schematic.

FIG. 1 is a side, cross-sectional view of a conventional backlight module.

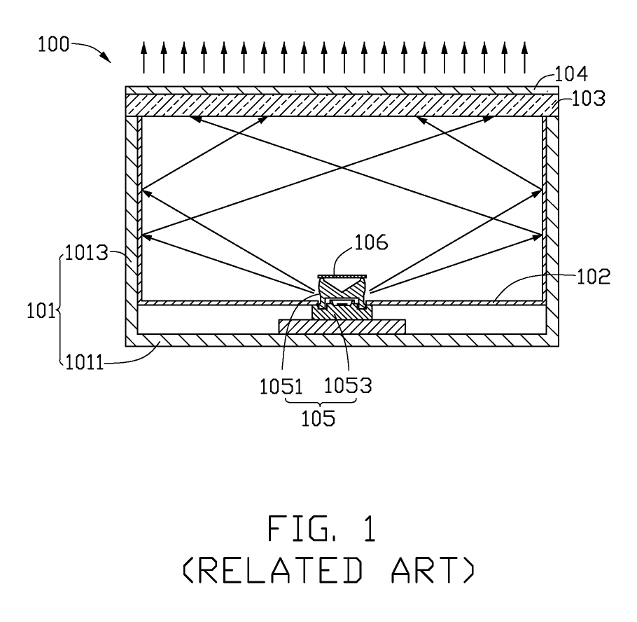

FIG. 2 is a side, cross-sectional view of a backlight module according to a first preferred embodiment of the present invention.

FIG. 3 is an isometric view of an optical plate of the backlight module of FIG. 2.

FIG. 4 is a side, cross-sectional view of the optical plate of FIG. 3, taken along line IV-IV thereof.

FIG. 5 is an enlarged view of a circled portion V of FIG. 2.

FIG. 6 is a side, cross-sectional view of an optical plate according to a second preferred embodiment of the present invention.

FIG. 7 is a side, cross-sectional view of an optical plate according to a third preferred embodiment of the present invention.

FIG. 8 is an isometric view of an optical plate according to a fourth preferred embodiment of the present invention.

FIG. 9 is an isometric view of an optical plate according to a fifth preferred embodiment of the present invention.

### DETAILED DESCRIPTION OF THE PREFERRED EMBODIMENTS

References will now be made to the drawings to describe preferred embodiments of the present optical plate and backlight module using the optical plate, in detail.

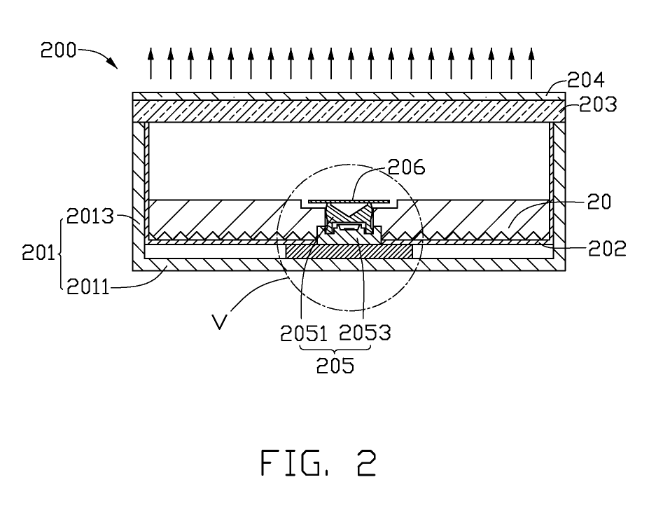

Referring to FIG. 2, a backlight module 200 in accordance with a first preferred embodiment of the present invention is shown. The backlight module 200 includes a housing 201, a light diffusion plate 203, an optical plate 20, at least a point light source 205, and at least a reflective member 206. The housing 201 includes a base 2011 and a plurality of connecting sidewalls 2013 extending from a periphery of the base 2011. The base 2011 and the connecting sidewalls 2013 cooperatively define a receiving cavity (not labeled). The light emitting diode 205 and the optical plate 20 are located in the receiving cavity. The light diffusion plate 203 is positioned on a top of the connecting sidewalls 2013.

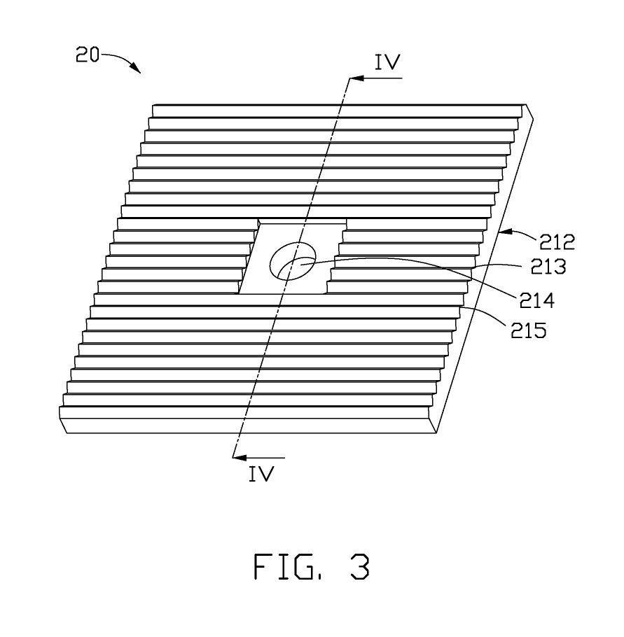

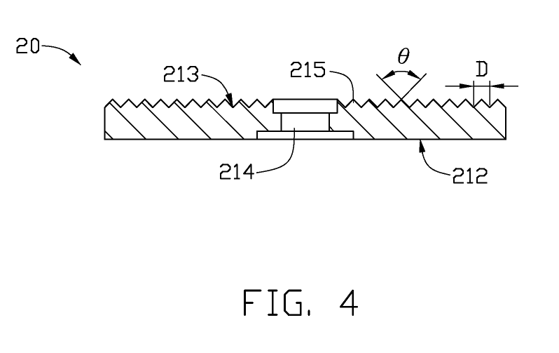

Referring to FIGS. 3 and 4, the optical plate 20 is substantially a rectangular sheet. The optical plate 20 includes a light output surface 212, and a bottom surface 213 on another side of the optical plate 20 opposite to the light output surface 212, a plurality of first protrusions 215 are formed on the bottom surface 213, and a lamp-receiving portion 214 is defined on the bottom surface 213. In an illustration embodiment, each of the first protrusions 215 is V-shaped. The first protrusions 215 are arranged regularly on the bottom surface 213 in a matrix manner, and further, the first protrusions 215 adjoin one another. A width D of each of the first protrusions 215 can be in a range from about 0.025 millimeters to 2 millimeters. An apex angle θ of each of the first protrusions 215 can be in a range from about 60 degrees to about 120 degrees. The lamp-receiving portion 214 is defined at a middle of the bottom surface 213. The lamp-receiving portion 214 is a through hole that runs through the bottom surface 213 and the light output surface 212. In an alternative embodiment, in order to receive the point light source 205 easily, the lamp-receiving portion 214 is a stepped hole.

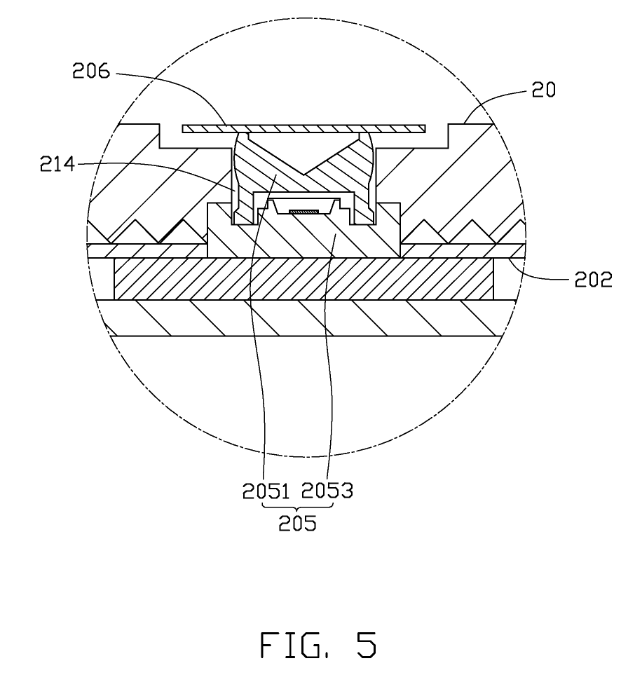

Referring to FIGS. 2 and 5, the optical plate 20 is located above the base 2011 of the housing 201. The light output surface 212 faces the light diffusion plate 203, and the bottom surface 213 is near the base 2011.

The point light source 205 can be a light emitting diode. The point light source 205 includes a base portion 2053 and an output portion 2051 on the base portion 2053. The base portion 2053 is electrically connected with the printed circuit board (not labeled) fixed on the base 2011. The output portion 2051 is substantially received in the lamp-receiving portion 214. The reflective member 206 is positioned at a top of the output portion 2051. In the illustration embodiment, the reflective member 206 is a rectangular reflective sheet. It should be pointed out that, the reflective member 206 can be also positioned on the light output surface 212 of the optical plate 20 above the lamp-receiving portion 214.

Light from the point light source 205 enters the optical plate 20 through sidewalls of the lamp-receiving portion 214. Since a surface structure of each of the first protrusions 215 changes gradually and continuously, a first amount of light projected on the first protrusions 215 are reflected along a predetermined direction, thereby changing a light emitting direction of the first amount of light. For example, when light projects to the first protrusions 215, the first amount of light is directed slightly towards a direction normal to the light output surface 212, thereby increasing the light that emits along the direction normal to the light output surface 212. Thus dark areas around the point light source 205 are brightened, and a uniformity of distribution of brightness is improved.

Furthermore, because of the light reflection of the reflective member 206, brightness directly above the point light source 205 of the backlight module 200 is decreased. Thus the uniformity of distribution of brightness is further improved. In addition, with the help of the reflective member 206, a volume of the backlight module 200 can be reduced.

In an alternative embodiment, the backlight module 200 includes a reflective module 202 engaged with the housing 201. A bottom board of the reflective module 202 adjoins to the bottom surface 213 of the optical plate 20. With the inclusion of the reflective module 202, an efficiency of utilization of light energy of the backlight module 200 is increased. Further, the reflective module 202 and the optical plate 20 can cooperatively increase light traveling along a direction normal to the light output surface 212.

In an alternative embodiment, the backlight module 200 includes a prism sheet 204 located on the light diffusion plate 203. The prism sheet 204 can refract the light, thereby increasing brightness of light illumination provided by the backlight module 200.

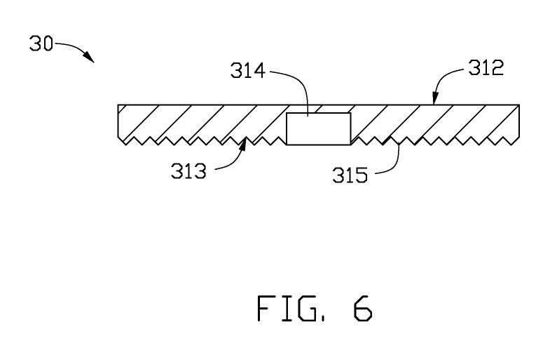

Referring to FIG. 6, an optical plate 30 according to a second preferred embodiment of the present invention is shown. The optical plate 30 includes a light output surface 312, a bottom surface 313 on another side of the optical plate 30 opposite to the light output surface 312, a plurality of first protrusions 315 formed on the bottom surface 313, and a lamp-receiving portion 314 is defined at the bottom surface 313. The lamp-receiving portion 314 is blind hole.

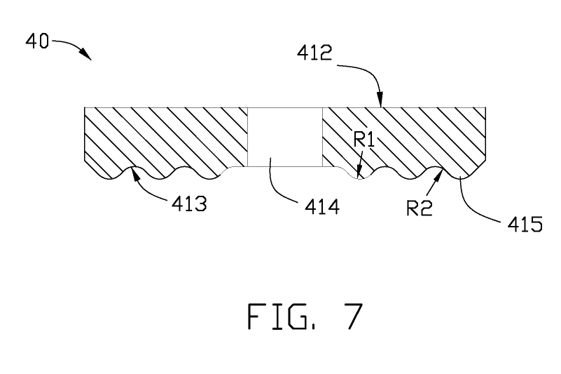

Referring to FIG. 7, an optical plate 40 according to a third preferred embodiment of the present invention is shown. The optical plate 40 includes a light output surface 412, a bottom surface 413 on another side of the optical plate 40 opposite to the light output surface 412, a plurality of first protrusions 415 formed on the bottom surface 413, and a lamp-receiving portion 414 is defined on the bottom surface 413. Each of the first protrusions 415 is V-shaped. Edges of each of the first protrusions 415 are smoothed, and radius of the smoothed edges R₁, R₂ are equal to or less than about 1.1 millimeters.

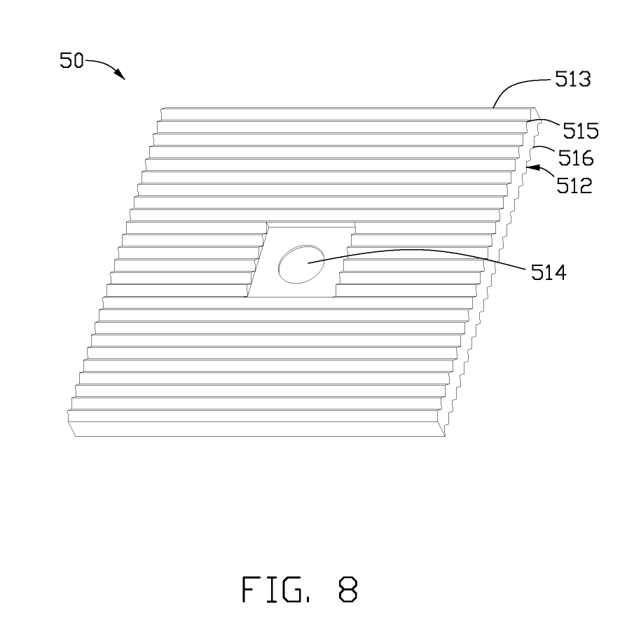

Referring to FIG. 8, an optical plate 50 according to a fourth preferred embodiment of the present invention is shown. The optical plate 50 includes a light output surface 512, a bottom surface 513 on another side of the optical plate 50 opposite to the light output surface 512, a plurality of first protrusions 515 formed on the bottom surface 513, a lamp-receiving portion 514 is defined on the bottom surface 513, and a plurality of second protrusions 516 formed on the light output surface 512. The second protrusions 516 on the light output surface 512 are arranged in a manner that is similar in arrangement as the first protrusions 515 on the bottom surface 513. It should be noted that the second protrusions 516 can be arranged in a manner that similar to, or differs from the arrangement of the first protrusions 515.

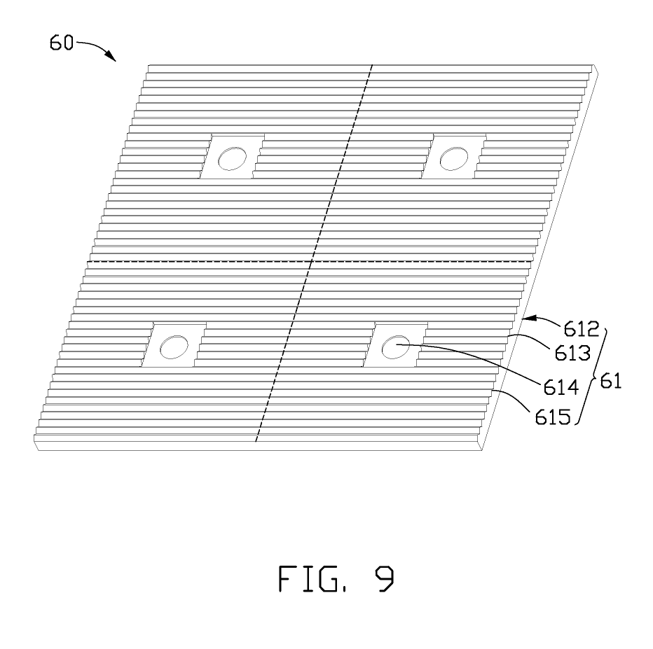

Referring to FIG. 9, an optical plate 60 according to a fifth preferred embodiment of the present invention is shown. The optical plate 60 includes a plurality of optical plate units 61. A shape of each optical plate units 61 is rectangular. Each optical plate units 61 includes a light output surface 612, and a bottom surface 613 on an opposite side of each optical plate units 61 to the light output surface 612, a plurality of first protrusions 615 formed at the bottom surface 613, a lamp-receiving portion 614 is defined at the bottom surface 613. The optical plate units 61 are arranged regularly in a matrix, and adjoin one another. It should be noted that the shape of each optical plate units 61 can be polygonal or circular.

It is noted that the scope of the present backlight module is not limited to the embodiments described above. For example, in order to increase brightness of light illumination provided by the backlight module, or mix different wavelength light rays generated by different light emitting diodes to produce white light, the optical plate or optical plate units can includes a plurality of lamp-receiving portions for receiving the point light sources. The first protrusions or the second protrusions can also be selected from the group consisting of conical protrusions, pyramidal protrusions, frustum of cone, and frustum of pyramid.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. An optical plate, comprising at least an optical plate unit, each optical plate unit comprising a light output surface, and a bottom surface opposite to the light output surface, a plurality of first protrusions formed at the bottom surface, and a lamp-receiving portion defined at the bottom surface.

2. The optical plate according to claim 1, wherein the first protrusions are selected from the group consisting of V-shaped protrusions, conical protrusions, pyramidal protrusions, frustum of cone, and frustum of pyramid.

3. The optical plate according to claim 2, wherein a width of each of the V-shaped protrusions is in a range from about 0.025 millimeters to about 2 millimeters; and an apex angle of each of the V-shaped protrusions is in a range from about 60 degrees to about 120 degrees.

4. The optical plate according to claim 3, wherein an apex angle of each of the V-shaped protrusions is in a range from about 60 degrees to about 120 degrees.

5. The optical plate according to claim 4, wherein edges of each of the V-shaped protrusions are smoothed, and a radius of the smoothed edges is equal to or less than about 1.1 millimeters.

6. The optical plate according to claim 1, wherein the first protrusions are arranged regularly at the bottom surface in a matrix manner.

7. The optical plate according to claim 1, wherein the lamp-receiving portion is one of a through hole and a blind hole.

8. The optical plate according to claim 1, wherein the lamp-receiving portion is in the middle of the optical plate.

9. The optical plate according to claim 1, wherein each optical plate unit further comprises a plurality of second protrusions formed on the light output surface.

10. A backlight module, comprising:
a housing having a base and a plurality of sidewalls extending from a periphery of the base;
at least a point light source having a light output portion located on the base;
a light diffusion plate positioned on a top of the sidewalls; and
an optical plate comprising at least an optical plate unit, each optical plate unit comprising a light output surface, and a bottom surface opposite to the light output surface, a plurality of first protrusions formed on the bottom surface, and a lamp-receiving portion defined on the bottom surface, wherein the light output portion is received in the lamp-receiving portion.

11. The backlight module according to claim 10, wherein the point light source is a light emitting diode, and the backlight module further comprises a reflective member that is positioned on the light output portion of the point light source, or on the light output surface of the optical plate above the lamp-receiving portion.

12. The backlight module according to claim 10, wherein the first protrusions are selected from the group consisting of V-shaped protrusions, conical protrusions, pyramidal protrusions, frustum of cone, and frustum of pyramid.

13. The backlight module according to claim 12, wherein a width of each of the V-shaped protrusions in a range from about 0.025 millimeters to about 2 millimeters, an apex angle of each of the V-shaped protrusions in a range from about 60 degrees to about 120 degrees.

14. The backlight module according to claim 13, wherein edges of each of the V-shaped protrusions are smoothed, and a radius of the smoothed edges is equal to or less than about 1.1 millimeters.

15. The backlight module according to claim 10, wherein the first protrusions are arranged regularly at the bottom surface in a matrix manner.

16. The backlight module according to claim 10, wherein the lamp-receiving portion is one of a through hole and a blind hole.

17. The backlight module according to claim 10, wherein each optical plate unit further comprises a plurality of second protrusions formed at the light output surface.

18. The backlight module according to claim 10, wherein the optical plate comprises a plurality of optical plate units, the optical plate units arranged side by side.

19. The backlight module according to claim 10, wherein each optical plate unit further comprises a reflective module engaged with the housing, and a bottom board of the reflective module adjoins to the bottom surface of the optical plate.
